(19) United States
(12) Patent Application Publication
(10) Pub. No.: US 2003/0046376 A1
(43) Pub. Date: Mar. 6, 2003

(54) System and method of automatic advertisement transaction

(75) Inventors: Hsiang-Tsun Yen, Taipei Hsien (TW); Sheng-Wu Chang, Taipei Hsien (TW)

Correspondence Address: Richard P. Berg, Esq., c/o LADAS & PARRY, 5670 Wilshire Boulevard, Suite 2100, Los Angeles, CA, 90036-5679, US

(73) Assignee: Synq Technology Inc.

(21) Appl. No.: 10/229,423

(22) Filed: Aug. 27, 2002

(30) Foreign Application Priority Data
Aug. 29, 2001 (TW) 90121386

(51) Int. Cl. G06F 15/177

(52) U.S. Cl. 709/220

(57) ABSTRACT

An automatic transaction system and method of advertising. The system comprises one server apparatus and at least one client apparatus. The first and second programs are preinstalled on the client apparatus and the server apparatus. When the first program sends a request message to the second program, the second program returns the most recent advertising schedule. When the first program receives the most recent advertising schedule with a plurality of time slot fields for selection therefrom, a time slot field is selected and the selected time slot field and advertising content are sent to the second program by the first program. A comparison is performed by the second program between the selected time slot field and a database. A transaction accepted/failed message is sent to the first program according to the comparison result.

### BACKGROUND OF THE INVENTION

1. Field of the Invention

The present invention relates to an automatic advertisement transaction system and an method thereof for advertising transaction on the Internet.

2. Description of the Related Art

Currently, the Internet is popular and many users access information thereby. Therefore, more and more companies promote their products or services on the Internet in various ways. One conventional way is to send e-papers together with advertising messages through e-mail. Another way is online advertising. For example, on the Internet, such online advertisings will often appear on a webpage, such as in advertising banner on the top or the bottom of the webpage. When an user views a webpage using a browser, the banner appears at the appropriate location and the user can then find out more information regarding the advertising by selecting the advertising (clicking through on the banner). This will cause a hyperlink to be generated by the browser using the information encapsulated in association with the banner to send a request for an object with a given URL address to a different appropriate website to access, for example, the advertiser's home page.

However, the advertising benefit or effectiveness is influenced by the popularity of the specific website. Conventionally, the advertiser evaluates the effectiveness between the visitor count and advertising charge for various websites when choosing websites on which to advertise. After the advertising contract is signed, the website usually provides periodical reports to the advertiser showing the click through rate for their banner and the popularity or visitor count of every webpage.

Conventionally, the advertiser relies on manpower and website reports to evaluate advertising effectiveness. One drawback is the cost of the manpower and another drawback is the lack of flexibility in advertising on individual pages of certain websites, in real time. For example, when a website holds an activity on a specific webpage at a given time, advertisers can only evaluate advertising effectiveness by speculating on the visitor count of the activity since conventional websites cannot provide the advertiser with real-time visitor counts for the webpage. Also, the website do not allow the advertiser to advertise in real time or designate a certain time slot in which to advertise.

Consequently, a website that provides the advertiser with a transaction that places advertising banner on a specific webpage in real time is called for, such that the advertiser need not rely on manpower and logged website reports to regularly evaluate advertising effectiveness, thereby providing markedly increased flexibility and cost-effectiveness.

### SUMMARY OF THE INVENTION

The present invention discloses a system and method of automatic advertisement transaction to provide online advertisement transactions. The present invention provides advertisers with real-time information to evaluate the advertising effectiveness of a website or webpage and also enable them to conclude a real-time transactions to place advertising on specific web pages.

The object of the present invention is to provide an automatic transaction flow between advertisers and websites to achieve a real-time transaction. According to the present invention, the advertiser can also evaluate the effectiveness of online advertising in real time to make informed decisions regarding cancellation, retention, or increase thereof.

To achieve the above-mentioned object, a client-server architecture is provided according to the present invention. A first program is installed on an advertiser site (i.e. a client terminal or a client apparatus) and a second program is installed on the website (i.e. a server site or a server apparatus). The automatic advertisement transaction is achieved by the interaction between the first and second programs.

To achieve the above-mentioned object, the present invention provides a system and method of automatic advertisement transaction for a client-server architecture. In the following, the server apparatus represents the website and the client apparatus represents the advertiser. The transaction system according to the present invention comprises one server apparatus and at least one client apparatus. The first program is preinstalled on the client apparatus and second program is preinstalled on the server apparatus to respond to the first program. When the first program sends a request message to the second program, the second program receives the request message and returns the most recent advertising schedule. When the first program receives the schedule, it is displayed by the first program with time slot fields on the advertising schedule for selection. When a time slot field on the advertising schedule is selected, the selected time slot field and predetermined advertising content are sent to the second program by the first program. The second program performs a comparison between the selected time slot field and a database to send a transaction accepted/failed message to the first program. The comparison ensures no conflict between the time slots selected by various clients. Moreover, the second program can further receive account information from the client apparatus and compares it with data from a corresponding financial institution to further dictate the nature of the transaction accepted message.

The present invention further provides a method of automatic advertisement transaction for a client-server architecture comprising the following steps:

(a). providing a first program preinstalled on a client apparatus by a server apparatus;

(b). sending back the most recent advertising schedule to the first program when receiving a request message from the first program by a second program preinstalled on the server apparatus, wherein the returned schedule comprises a plurality of time slot fields from which the client apparatus can make a selection;

(c). performing a comparison between a selected time slot field and a database after the second program receives the selected time slot field and predetermined advertising content;

(d). sending a transaction accepted/failed message to the first program according to the comparison by the second program; and

(e). possible receipt of account information for the client apparatus by the second program to be compared with data from a corresponding financial institution and thereby further configuring the returned message.

### BRIEF DESCRIPTION OF THE DRAWINGS

The present invention will become more fully understood from the detailed description given herein below and the accompanying drawings, given by way of illustration only and thus not intended to be limitative of the present invention. In the drawings,

FIG. 1 is a schematic drawing illustrating a transaction environment according to one embodiment of the present invention;

FIG. 2 is a block diagram illustrating the detail of the server apparatus 100 and the client apparatus 103 in FIG. 1;

FIG. 3 is a block diagram illustrating the detail in the client apparatus 103; and

FIG. 4 is a flowchart illustrating an automatic advertisement transaction between the client apparatus 103 and the server apparatus 100 according to one embodiment of the present invention.

### DETAILED DESCRIPTION OF THE INVENTION

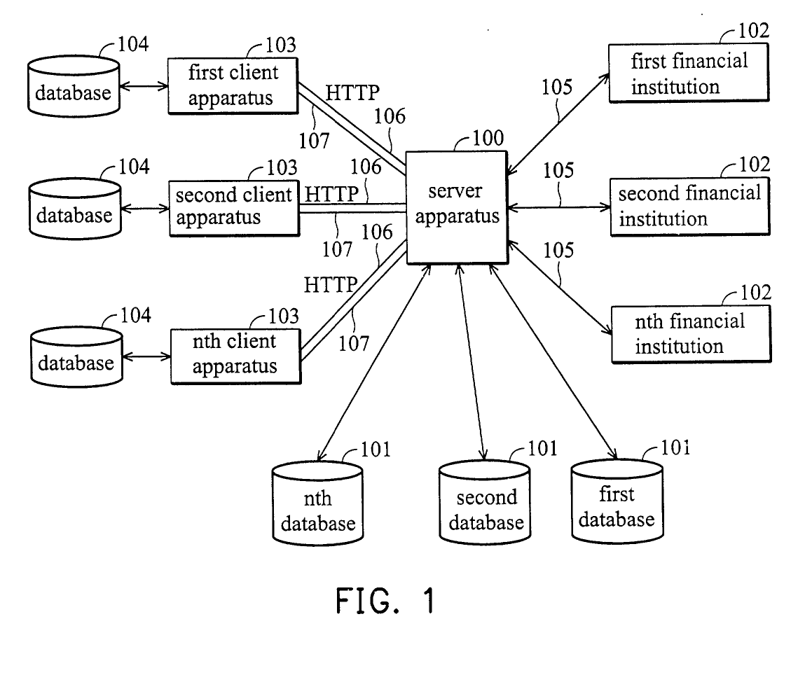

FIG. 1 illustrates a transaction environment according to one embodiment of the present invention, comprising a server apparatus 100 and at least one client server 103. The server apparatus 100 and the client apparatus 103 are connected to at least one database 101 and 104 respectively. The server apparatus 100 can also connect to financial institutions 102. The client apparatus 103 connects to server apparatus 100 to browse information via network 106 that communicates by HTTP protocol. The client apparatus 103 also connects to the server apparatus 100 via network 107 to transmit messages according to the present invention. Preferably, the network 107 communicates by UDP protocol, but is not limited thereto. The network 107 can also communicate by HTTP protocol as network 106. Another network 105 is specified between the server apparatus 100 and financial institutions 102 to check account information from the client apparatus 103.

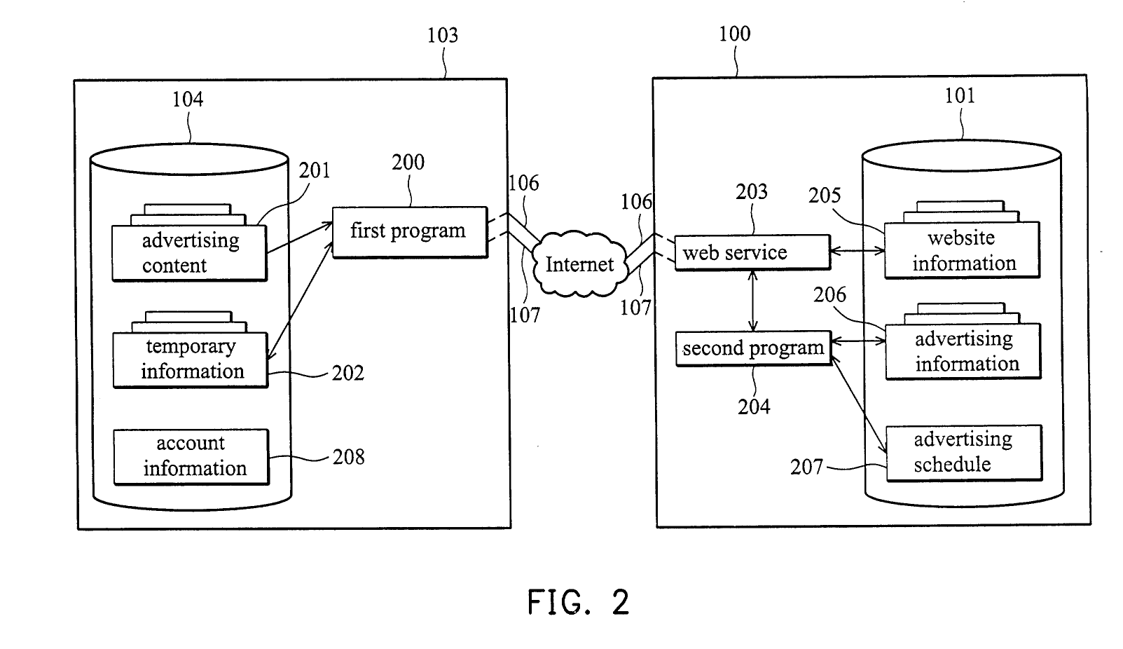

FIG. 2 illustrates the detail of the server apparatus 100 and the client apparatus 103 in FIG. 1 and the corresponding databases 101 and 104. In FIG. 2, a first program 200 is preinstalled on the client apparatus 103 and a web service 203 (e.g. Microsoft IIS) is installed in server apparatus 100 to allow the first program 200 to browse the website information 205 in the database 101 of the server apparatus 100. A second program 204 is also preinstalled in the server apparatus 100 to respond to requests from the first program 200 to access the advertising information 206 and advertising schedule 207 in the database 101. The database 104 of the client apparatus 103 also provides advertising content 201, temporary information 202 and account information 208, which can be accessed by the first program 200 to respond to the second program 204.

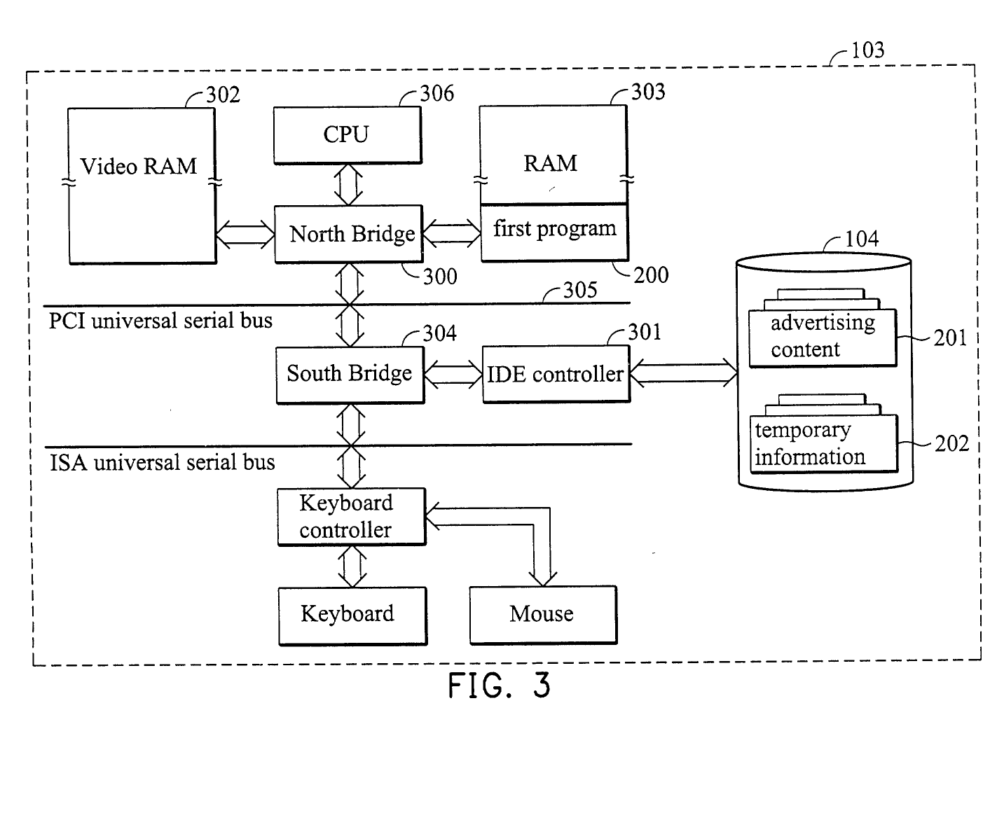

FIG. 3 illustrates the detail in the client apparatus 103 and the database 104. The client apparatus 103 can be a computer as shown in FIG. 3. In the following description, only the relative parts of the computer will be described in detail without irrelevant structures in the computer. In FIG. 3, when the client apparatus 103 is started, the first program is loaded into RAM 303 which is connected to the north bridge 300 to interface with the other units in the client apparatus 103. Moreover, the video RAM 302 is controlled by the north bridge 300 and the AGP controller 307 to provide a display interface such that the user (i.e. the advertiser) can access information by the first program on the screen. In the client apparatus 103, a plurality of instructions of the first program is executed by CUP 306. The CPU 306 accesses the advertising content 201 and the temporary information 202 in the database 104 via the north bridge 300, the PCI universal serial bus 305, the south bridge 304 and the IDE controller 301. The client apparatus 103 communicates by the server apparatus 100 via a modem (not shown) or other wired or wireless network equipment as shown in FIG. 2.

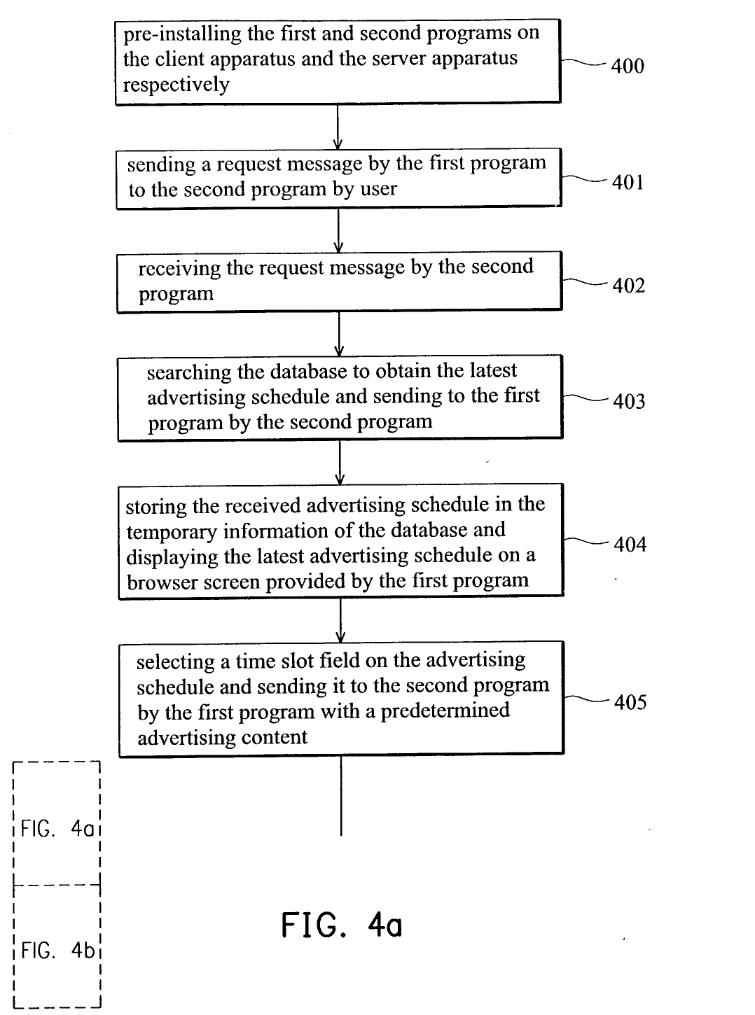

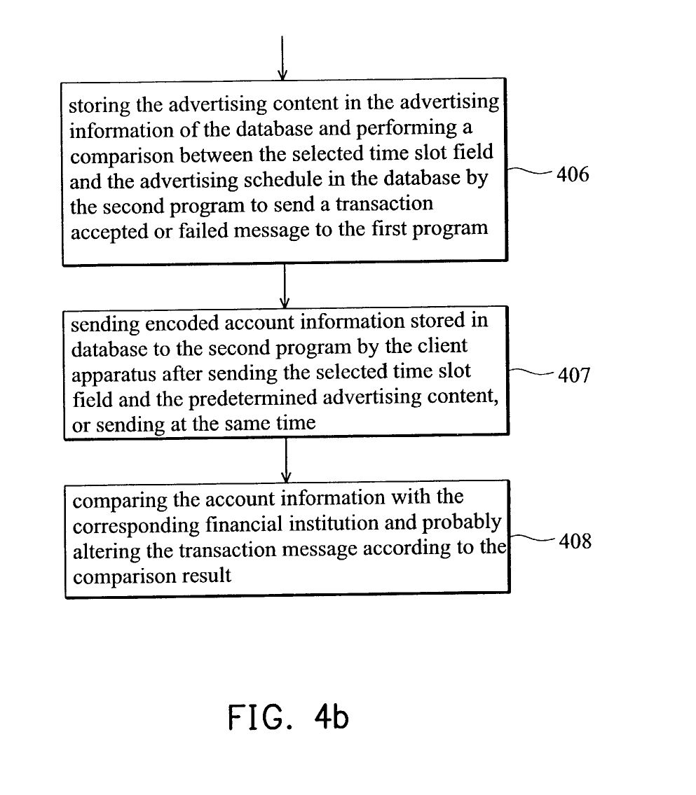

FIG. 4 is a flowchart of an automatic advertisement transaction between the client apparatus 103 and the server apparatus 100 according to one embodiment of the present invention. A first program and a second program are preinstalled on the client apparatus 103 and the server apparatus 100 respectively (Step 400). The first and second programs can programmed by any available network software language, e.g. JAVA SCRIPT or VB SCRIPT. After the first program 200 is installed on the client apparatus 103, the first program 200 sends a request message by a user (Step 401).

The second program 204 of the server apparatus 100 receives the request message (Step 402) and searches the database 101 to obtain the latest advertising schedule 204 and sends it to the first program 200 (Step 403). The first program 200 stores the received advertising schedule in the temporary information 202 of the database 104. The latest advertising schedule 207 is displayed on a browser screen provided by the first program 200 by the APG controller 307 and the video RAM 302 (Step 404). The latest advertising schedule displayed on the browser provides the latest advertising time lots for selection. When a time slot field is selected, the selected time slot field is sent to the second program 204 by the first program 200 and the user also sends predetermined advertising content stored in the advertising content 201 of the database 104 via the screen (Step 405).

The second program 204 stores the advertising content in the advertising information 206 of the database 101 and performs a comparison between the selected time slot field and the advertising schedule 207 in the database 101 to ensure if any client has booked the same time slot. If the selected time slot has already been booked, the second program 204 sends a transaction failed message to the first program 200. If the selected time slot has not been booked, the second program 204 sends a transaction accepted message to the first program 200 (Step 406) and also updates the advertising schedule 207 in the database 101 to reserve the selected time slot for the client (i.e. the advertiser).

The client apparatus 103 can also send encoded account information 208 stored in database 104 to the second program 204 after the selected time slot field and the predetermined advertising content have been sent, or is sent at the same time (Step 407). The second program 204 receives the account information from the client apparatus 103 and compares it with the corresponding financial institution. According to the comparison result, the transaction may be altered and the transaction message may be re-sent (Step 408).

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An automatic advertisement transaction system for a client-server architecture, comprising:
a server apparatus which enables installation on a client terminal of a first program to send a request message to the sever apparatus, wherein when the server apparatus receives the request message, the server apparatus sends the most recent advertising schedule back to the client terminal to be displayed by the first program, and when a time slot field on the advertising schedule is selected, the selected time slot field and predetermined advertising content are sent to the server apparatus by the first program and the server apparatus performs a comparison between the selected time slot field and a database to send a transaction accepted/failed message to the client terminal.

2. The system as claimed in claim 1, wherein a second program is preinstalled on the server apparatus to receive the request message and to return the advertising schedule.

3. The system as claimed in claim 2, wherein the second program provides a means for receiving the selected time slot field and the advertising content.

4. The system as claimed in claim 2, wherein the second program compares the selected time slot field with a plurality of available time slots in the database to determine the nature of the message to be sent.

5. The system as claimed in claim 4, wherein the second program further receives account information for the client terminal and compares the account information with data from a corresponding financial institution and thereby further determines the nature of the message to be sent.

6. An automatic advertisement transaction system for a client-server architecture, comprising:
a client apparatus preinstalled with a first program to send a request message; and
a server apparatus preinstalled with a second program to receive the request message and return a most recent advertising schedule;
wherein when the first program receives the most recent advertising schedule, the most recent advertising schedule is displayed by the first program, and when a time slot field on the advertising schedule is selected, the selected time slot field and predetermined advertising content are sent to the second program by the first program, and the second program performs a comparison between the selected time slot field and a database to send a transaction accepted/failed message to the first program.

7. The system as claimed in claim 6, wherein the second program further receives account information from the client apparatus and compares the account information with data from a corresponding financial institution, and thereby further determines the nature of the message to be sent.

8. A method of automatic advertisement transaction for a client-server architecture, the method comprising steps of:
providing a first program preinstalled on a client apparatus by a server apparatus;
sending the most recent advertising schedule to the first program when receiving a request message from the first program by a second program preinstalled on the server apparatus, wherein the returned schedule comprises a plurality of time slot fields from which the client apparatus can make a selection;
performing a comparison between the selected time slot field and a database after the second program receives the selected time slot field and predetermined advertising content; and
sending a transaction accepted/failed message to the first program according to the comparison by the second program.

9. The method as claimed in claim 8, further comprising receipt of account information for the client apparatus by the second program to be compared with data from a corresponding financial institution and thereby further determine the nature of the message to be sent.

10. A method of automatic advertisement transaction for a client-server architecture, the method comprising steps of:
sending a request message to a server apparatus from a client apparatus;
sending the most recent advertising schedule to the client apparatus by the sever apparatus when receiving the request message;
displaying the most recent advertising schedule on the client apparatus upon receipt thereof;
selecting a time slot field from the display and returning the selection to the server apparatus together with predetermined advertising content;
performing a comparison between the selected time slot field and a database when the server apparatus receives the selected time slot field and the advertising content; and
sending a transaction accepted/failed message according to the comparison by the server apparatus to the client apparatus.

11. The method as claimed in claim 10, wherein a first program is preinstalled on the client apparatus to send the request message.

12. The method as claimed in claim 11, wherein the display is provided by the first program to display the advertising schedule when received.

13. The method as claimed in claim 11, wherein the first program further provides a means for returning the selected time slot field and the advertising content.

14. The method as claimed in claim 11, wherein the first program further provides a means for sending the account information of the client apparatus.

15. The method as claimed in claim 10, wherein a second program is preinstalled on the server apparatus to receive the request message and return the advertising schedule.

16. The method as claimed in claim 15, wherein the second program provides a means for receiving the selected time slot field and the advertising content.

17. The method as claimed in claim 15, wherein the comparison is performed by the second program to compare the selected time slot field with a plurality of available time slots in the database to determine the nature of the message to be sent.

18. The method as claimed in claim 16, wherein the second program further receives account information from the client apparatus and compares the account information with data from a corresponding financial institution, and thereby further determines the nature of the message to be sent.
